(19) United States
(12) Patent Application Publication
(10) Pub. No.: US 2003/0046144 A1
(43) Pub. Date: Mar. 6, 2003

(54) System and method for anonymous message forwarding and anonymous voting

(75) Inventors: David Kingsley Clark, Cedar Park, TX (US); Theodore Jack London Shrader, Austin, TX (US); Julie Louise Gilbreath, Liberty Hill, TX (US)

Correspondence Address: Joseph T. Van Leeuwen, P.O. Box 81641, Austin, TX, 78708-1641, US

(73) Assignee: International Business Machines Corporation

(21) Appl. No.: 09/941,252

(22) Filed: Aug. 28, 2001

(51) Int. Cl. G06F 17/60

(52) U.S. Cl. 705/12

(57) ABSTRACT

A system and method for anonymous message forwarding architecture is presented. A voter sends a vote selection to a mail forwarding server that removes the identity of the voter. The mail forwarding server has administrative options given to it by the receiving server. Administrative options include the ability to manage who is authorized to vote, how often an individual is allowed to vote, and confirmation of accepting a vote from an authorized user, or confirmation of rejecting a vote from an unauthorized user. The mail forwarding server sends the anonymous vote selection to the receiving server for vote calculation. The mail forwarding server also has the ability to perform vote selection calculation and may send a single, compiled file to the receiving server.

### BACKGROUND OF THE INVENTION

1. Technical Field

The present invention relates in general to a method and system for receiving mail without the identity of the sender. More particularly, the present invention relates to a system and method for using a mail forwarding architecture to remove the identity of an individual when casting an election ballot.

2. Description of the Related Art

The ability to send a message without identifying the sender of the message has many useful purposes. For example, an employee may provide more honest feedback to employer questionnaires if the employee is confident that his identity is not revealed. Another example of when an individual may not want his identity revealed is when he is filing a complaint about a neighbor to a homeowner association. He may want to have his complaint heard, but may not want to create hardship between him and his neighbor.

Voting is also a time when an individual may want to be anonymous. Voter turnout has been an ongoing concern and many attempts have been made to increase the percentage of people voting. Many individuals are working during the day and have family activities in the evening. People are also accustomed to performing business activity electronically, such as through email. Voters often become frustrated standing in long lines during the voting day to cast a vote. The existing voting systems are not accommodating to the way people perform modern business electronically. Voter turnout may be increased if a voter is able to vote over a computer network, such as the Internet, during any time of the voting day.

A challenge found with existing art is to ensure a voter's identity is not revealed, and at the same time log who is voting so the number of times a person votes is tracked. Another challenge with existing art is that the receiving server of anonymous email systems do not have the ability to manage who sends anonymous emails and how often. Receiving servers may not have the ability to inform forwarding servers which emails should be blocked, and which emails should be forwarded. Receiving servers may also not have the ability to inform the forwarding server how many times an individual may vote. This helps protect the recipient mail client against mail overload, or denial of service attacks.

Another challenge found with existing art is that existing architectures have a solution for mail forwarding, but not anonymous processing. Others deal with anonymous processing, but do not log who sends the email and how often. More challenges found with existing art are that some require a sender to use a specialized ISP or mail service and do not use a forwarding server that is used as a management construct.

What is needed, therefore, is a message forwarding architecture that has administrative options available to the recipient mail client.

### SUMMARY

It has been discovered that by providing a mail forwarding architecture that manages and records relevant sender information while providing an anonymous message to be sent to a receiving server, a benefit is achieved by the receiving server. A voter mailing procedure is initiated by either the receiving server or forwarding server. The voter mailing procedure may be performed electronically as well as performed through a mail service such as the United States Postal Service for voters that do not have access to electronic mail.

Voters receive the vote requests and cast their votes through a private client, such as a home computer, or a public client such as a computer in a voting booth at a public library. Voters can also use a telephone to access the system and cast their votes.

The forwarding server receives a vote selection from an individual. The mail forwarding server retrieves authorized voter information and administrative options from a database. The forwarding server may have administrative options that are specified by the receiving server. For example, the receiving server may want to limit the number of times a single individual (or authorized email address) can vote in order to prevent a multiple voting email overload, or denial of service attack. The forwarding server determines whether the individual who sent the vote selection is authorized to vote. If the individual is authorized to vote, the forwarding server logs the individual and removes the identity from the vote selection. Removing the identity may include the senders name and email address, reply-to name, IP address of the sender, IP address of the sender's ISP, and timestamp information. Once the identity is removed, the forwarding server sends the anonymous vote selection to the receiving server. The forwarding server may also retain individual vote selections and send a single file to the receiving server that includes a summation of vote selections. The receiving server tabulates the votes and selects a winner of the election based on the tabulation. There may be multiple receiving servers in cases where each precinct or county is implemented with a separate server.

This invention provides an asynchronous solution that can leverage security standards, such as Secure/multipurpose Internet Mail Extensions (S/MIME), as part of its solution architecture.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram of a mail forwarding architecture with a receiving server sending voter requests;

FIG. 2 is a diagram of a mail forwarding architecture with a forwarding server sending voter requests;

FIG. 3 is a high level flow chart showing voter request being sent out and responses received;

FIG. 4 is a flow chart showing a forwarding server receiving votes, removing the voter identity, and sending a file to a receiving server;

FIG. 5 is a flow chart showing a forwarding server receiving votes, removing the voter identity, and sending the anonymous vote to a receiving server; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

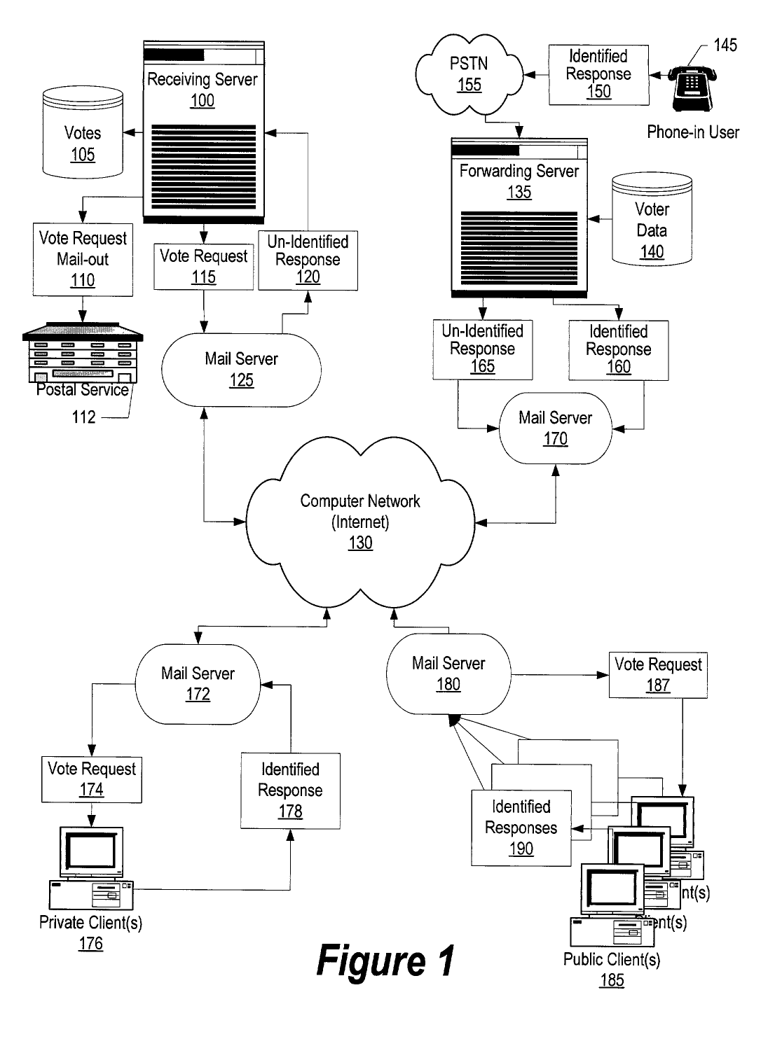

FIG. 1 is a diagram of a mail forwarding architecture with a receiving server sending voter requests. Those skilled in the art can appreciate that this architecture can be used for other activities besides voting where anonymous mail is preferred. For example, this architecture can be used to construct an employee feedback system or homeowner feedback system.

Receiving server 100 initiates a voting poll by sending out Vote Request Mail-out 110 and electronic vote request 115. Vote Request Mail-out 110 is sent to Postal Service 112 for delivery through a mail service, such as the United States Postal Service. Vote request mail-outs may be sent to individuals that do not have access to electronic mail or in circumstances where physical mailing is preferred. Vote request mail-outs sent through a postal service may also be sent to each authorized voter regardless of electronic mail capability to increase the chances of voter turnout. Vote request mail-outs may provide additional voting instructions, such as locations of public voting clients and other voting instructions. Electronic vote request 115 is sent to mail server 125. Mail server 125 sends the vote request to computer network 130 such as the Internet. The vote request is sent through Computer Network 130 to mail server 172, which delivers vote request 174 to Private Client 176. Private Client 176 may be a client that has electronic mail capability for a particular individual who is authorized to vote, either in a company or at home. Vote request 115 includes voting instructions and may include an electronic ballot, or template that the recipient can use to initiate one or more votes. The authorized voter who has electronic mail capability for Private Client 176 receives the vote request, and casts his vote with a responsive email message. The role of Vote Request 187 in the context of Public Client(s) 185 is to allow specialized software to process inputs and outputs related to the ballot that is displayed to the user.

The identity of Private Client 176 and vote responses are included in Identified Response 178, which is sent to Mail Server 172. Mail Server 172 sends the identified response through Computer Network 130 to Mail Server 170. Mail Server 170 sends Identified Response 160 to Forwarding Server 135 for processing. Forwarding server 135 retrieves voter information from voter data store 140 and determines whether Identified Response 160 is from an authorized voter. For example, voter authorization may be performed by looking up an e-mail address or by including an authorized digital certificate or digital signature in the e-mail.

Forwarding Server 135 may also receive phone-in responses from voters that do not cast votes by electronic mail. For example, voters may use the telephone to cast a vote using the telephone if they receive a vote request from the post office and do not have access to electronic mail. Phone-in User 145 sends Identified Response 150 through Public Switch Telephone Network (PSTN) 155 to Forwarding Server 135. Forwarding Server 135 also retrieves Phone-in User information from voter data store 140. Identified Response 150 includes a vote selection of Phone-in user 145 and identity information such as an employee identification number, social security number, or account number. In addition, a password such as a Personal ID Number (PIN) can be used for added security. The identity of the voter is used to determine authorization privileges.

Forwarding server 135 may also receive vote responses from Public Client(s) 185 which may be sent from a voting booth located in a library or other publicly accessible place. An authorized voter enters the voting booth and inputs his unique identification number such as a social security number or account number, and vote selection into Public Client 185. In addition, a password such as a Personal ID Number (PIN) can be used for added security. Public Client 185 sends Identified Responses 190 to Mail Server 180. Mail Server 180 sends the identified response through Computer Network 130 to Mail Server 170. Mail Sever 170 sends Identified Response 160 to Forwarding Server 135. Forwarding server 135 retrieves voter information from Data 140 and determines whether Identified Response 160 is from an authorized voter. Since Identified Response 160 is generated from Public Client 185, Forwarding Server 135 may not be able to use an e-mail address look-up to determine authorization, but may use information such as the user's identification number, social security number, PIM code, or account number that uniquely identifies the user and is included in Identified Response 160.

When Forwarding Server 135 receives an authorized voter response from either Private Client 176, Public Client 185, or Phone-in User 145, Forwarding Server 135 removes the voter identity of the response and sends Un-Identified Response 165 to Mail Server 170. Forwarding Server 135 may send Un-identified Response 165 for each voter response, or Forwarding Server 135 may store voter responses and send a single un-identified response which includes the summation of vote selections received. Mail Server 170 sends Un-Identified Response 165 through Computer Network 130 to Mail Server 125. Receiving Server 100 verifies that Un-Identified Response 120 is from Forwarding Server 135 by using public/private key encryption or other security mechanisms. Un-Identified Response 120 is received by Receiving Server 100, which analyzes the vote response and stores it in Data Store 105.

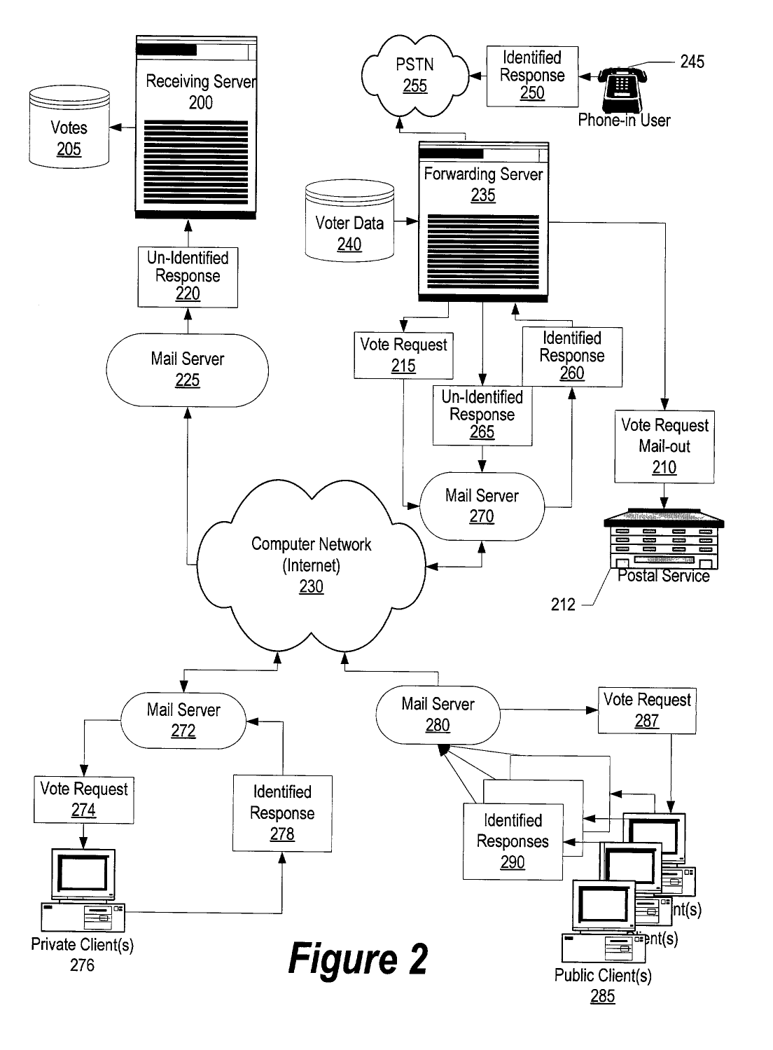

FIG. 2 is a diagram of a mail forwarding architecture with a forwarding server sending voter requests. In FIG. 2, the forwarding server is responsible for sending voter mail-outs, whereas in FIG. 1 the receiving server is responsible for sending voter requests.

Forwarding server 235 initiates a voting poll by sending out Vote Request Mail-out 210 and electronic vote request 215. Vote Request Mail-out 210 is sent to Postal Service 212 for delivery through a mail service, such as the United States Postal Service. Vote request mail-outs may be sent to individuals who do not have access to electronic mail or in circumstances where physical mailing is preferred. Vote request mail-outs sent through a postal service may also be sent to each authorized voter regardless of electronic mail capability to increase the chances of voter turnout or to satisfy election requirements. Vote request mail-outs may provide additional voting instructions, such as locations of public voting clients and other voting instructions. Electronic vote request 215 is sent to mail server 270. Mail server 270 sends the vote request through computer network 230 to mail server 272, which delivers vote request 274 to Private Client 276. Private Client 276 may be a client that has electronic mail capability for a particular individual who is authorized to vote, either in a company or at home. Vote request 215 includes voting instructions and may include an electronic ballot, or template that the recipient can use to initiate one or more votes. The authorized voter who has electronic mail capability for Private Client 276 receives the vote request, and casts his vote with a responsive email message. The role of Vote Request 287 in the context of Public Client(s) 285 is to allow specialized software to process inputs and outputs related to the ballot that is displayed to the user.

The identity of Private Client 276 and vote response are included in Identified Response 278, which is sent to Mail Server 272. Mail Server 272 sends the identified response through Computer Network 230, to Mail Server 270. Mail Server 270 sends Identified Response 260 to Forwarding Server 235 for processing. Forwarding server 235 retrieves voter information from voter data store 240 and determines whether Identified Response 260 is from an authorized voter. For example, voter authorization may be performed by looking up an e-mail address or by including an authorized signature certificate in the e-mail.

Forwarding Server 235 may also receive phone-in responses from voters that do not cast votes by electronic mail. For example, voters may use the telephone to cast a vote using the telephone if they receive a vote request from the post office and do not have access to electronic mail. Phone-in User 245 sends Identified Response 250 through Public Switch Telephone Network (PSTN) 255 to Forwarding Server 235. Forwarding Server 235 also retrieves Phone-in user information from Data Store 240. Identified Response 250 includes a vote of Phone-in user 245 and identity information such as an employee identification number, social security number, or account number. In addition, a password such as a Personal ID Number (PIN) can be used for added security. The identity of the voter is used to determine authorization privileges.

Forwarding server 235 may also receive vote responses from Public Client(s) 285 which may be sent from a voting booth located in a library or other publicly accessible place. An authorized voter enters the voting booth and inputs his unique identification number, such as an employee number, social security number, or account number, and vote selection into Public Client 285. In addition, a password such as a Personal ID Number (PIN) can be used for added security. Public Client 285 sends Identified Responses 290 to Mail Server 280. Mail Server 280 sends the identified response through Computer Network 230 to Mail Server 270. Mail Server 270 sends Identified Response 260 to Forwarding Server 235. Forwarding server 235 retrieves voter information from Data 240 and determines whether Identified Response 260 is from an authorized voter. Since Identified Response 260 is generated from Public Client 285, Forwarding Server 235 may not be able to use an e-mail address look-up to determine authorization, but may use information such as the employee's identification number, social security number, PIN codes, or account number that uniquely identifies the user and is included in Identified Response 260.

When Forwarding Server 235 receives an authorized voter response from either Private Client 276, Public Client 285, or Phone-in User 245, Forwarding Server 235 removes the voter identity of the response and sends Un-Identified Response 265 to Mail Server 270. Forwarding Server 235 may send Un-identified Response 265 for each voter response, or Forwarding Server 235 may store voter responses and send a single un-identified response which includes the summation of vote selections received. Mail Server 270 sends Un-Identified Response 265 through Computer Network 230 to Mail Server 225. Receiving Server 200 verifies that Un-Identified Response 220 is from Forwarding Server 235 by using public/private key encryption or other security mechanisms. Un-Identified Response 220 is received by Receiving Server 200, which analyzes the vote response and stores it in Data Store 205.

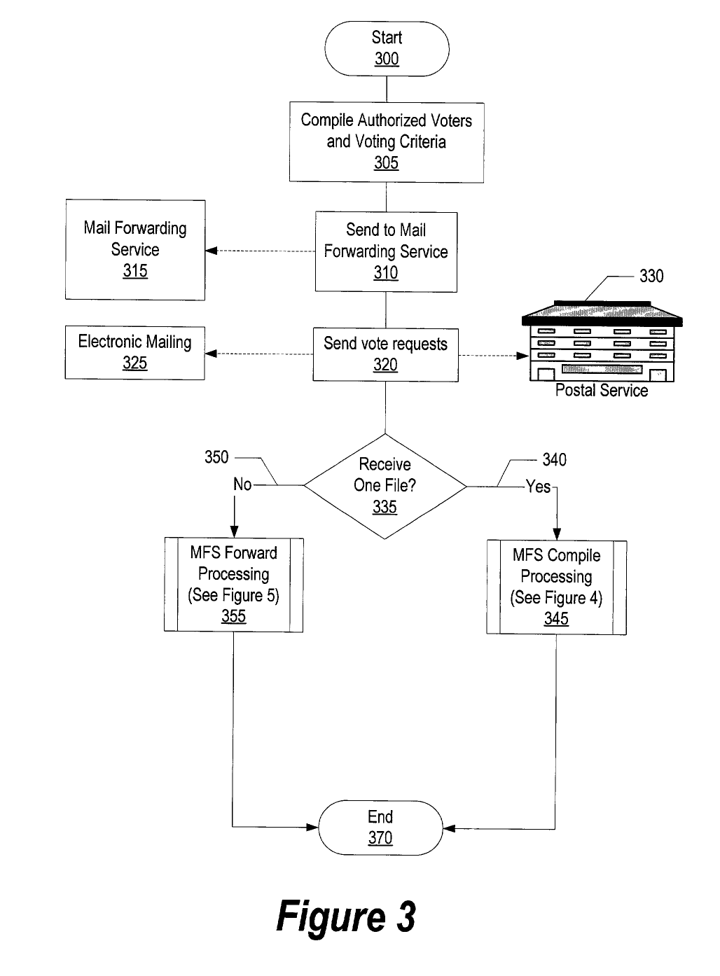

FIG. 3 is a high level flow chart showing voter requests being sent out and responses received. Processing commences at 300, whereupon a list of authorized voters is compiled along with voting criteria. For example, voting criteria may allow voters to vote multiple times, or a single time.

The authorized voter list and voting criteria are sent to Mail Forwarding Service 315 (step 310). The mail forwarding service is responsible for adhering to the voting criteria and allowing authorized voters to cast their vote. Electronic Mailing 325 and Post Office 330 send out vote requests (step 320). For example, a company may send out vote requests to its employees or shareholders by electronic mail. However, some recipients may not have the ability to access electronic mail. The company may mail out a voter request to those individuals through the post office.

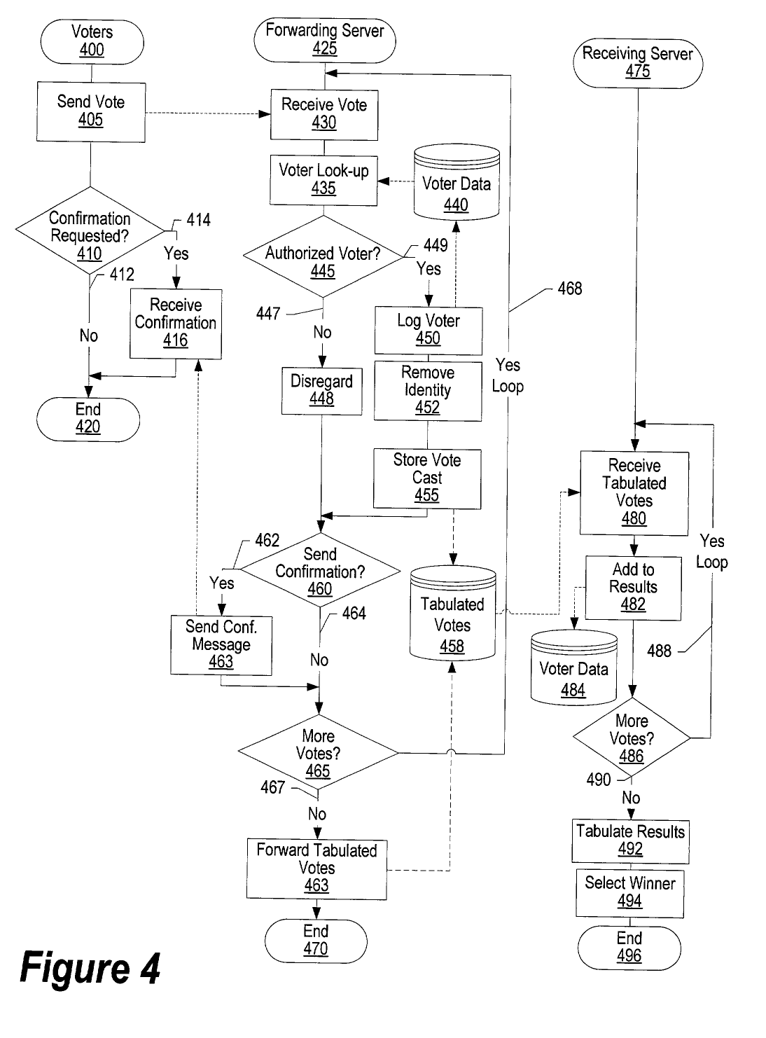

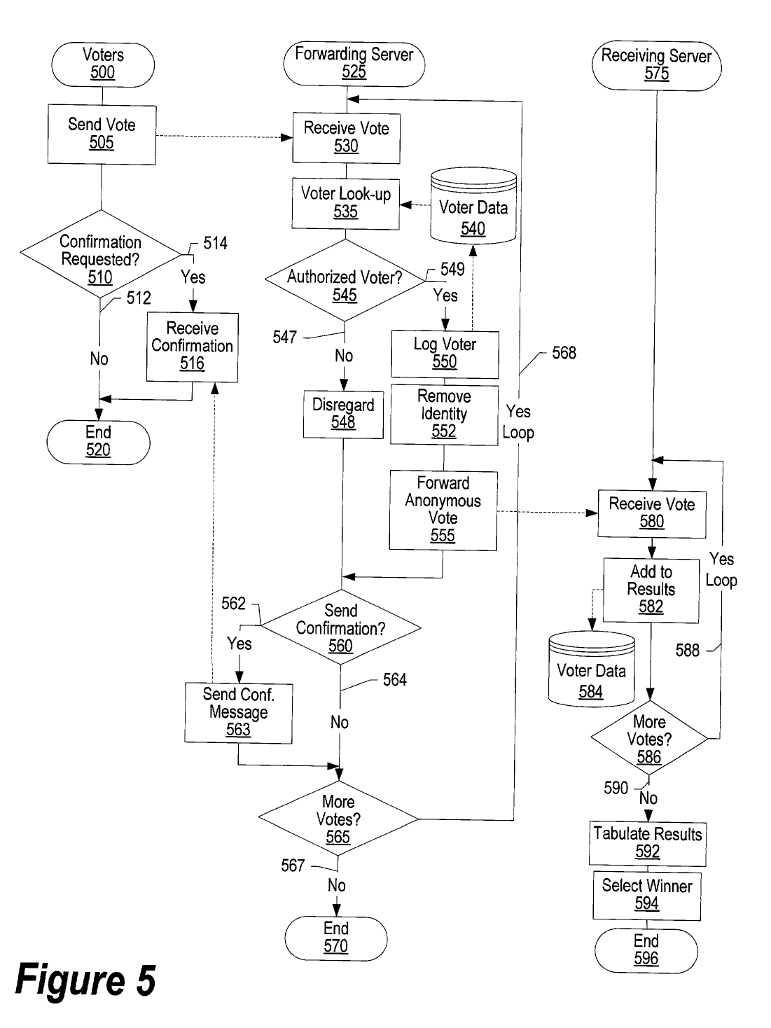

A determination is made as to whether the receiving server will receive one file of tabulated votes from the mail forwarding service or will receive multiple messages (decision 335). If the receiving server will receive one file, decision 335 branches to “Yes” branch 340 whereupon Mail Forwarding Service (MFS) Compilation is processed (pre-defined process block 345, see FIG. 4 for further details). For example, the receiving server may instruct the forwarding server to manage the voting tabulation and receive a file with the tabulated voting results. On the other hand, if the receiving server will receive each anonymous email from the mail forwarding service and perform voting tabulation itself, decision 335 branches to “No” branch 350 whereupon MFS Forwarding processing is performed (pre-defined process block 355, see FIG. 5 for further details). Processing voter requests ends at 370.

FIG. 4 is a flow chart showing a forwarding server receiving votes, removing the voter identity, and sending a file to a receiving server. Voter processing commences at 400, whereupon a voter sends a vote to the forwarding server (step 405). A determination is made as to whether the voter will receive a confirmation of his vote being processed by the forwarding server (decision 410). If a confirmation will not be sent, decision 410 branches to “No” branch 412 whereupon voter processing ends at 420. On the other hand, if a confirmation will be sent, decision 414 branches to “Yes” branch 414 whereupon processing waits for a confirmation (step 416). Once the confirmation is received at step 416, voter processing ends at 420.

Mail forwarding server processing commences at 425, whereupon the forwarding server receives a vote (step 430). The voter identity is retrieved from voter data store 440 (step 435). Voter data store 440 includes a log of who is authorized to vote and how many times a voter can vote. A determination is made as to whether the voter is authorized to vote (decision 445). For example, an authorization may be determined from an email address or determined from an authorized digital certificate or digital signature. It may also come from a voter entering a unique identifier and password on a touch-tone phone.

If the voter is not authorized to vote, decision 445 branches to “No” branch 447 whereupon the vote is disregarded (step 448). On the other hand, if the voter is authorized to vote, decision 445 branches to “Yes” branch 449 whereupon the voter identity is logged in voter data store 440 (step 450). The voter identity is removed at step 452. Removing voter identity may include removing the email address of the voter and relevant IP address information. The cast vote is stored in tabulated votes store 458 (step 455). A determination is made as to whether a confirmation is feasible and requested by the voter to notify him that his vote is accepted or rejected (decision 460). For example, a confirmation may be feasible if a voter sent a vote from a private computer, but not feasible if a voter sent a vote from a public computer in a public library. In order to send a confirmation to an authorized voter whose identity has been removed, the voters' identity may have to be retrieved from the voter log file or retained in memory until the confirmation message has been sent.

If a confirmation will be sent, decision 460 branches to “Yes” branch 462 whereupon a confirmation is sent to the voter (step 463). The voter receives the confirmation at step 416, and voter processing ends at 420. On the other hand, if a confirmation will not be sent, decision 460 branches to “No” branch 464 whereupon a determination is made as to whether there are more votes (decision 465). This decision may be based on a time restriction (i.e. no votes after 4pm on November 4th). If there are more votes, decision 465 branches to “Yes” branch 468 which loops back to wait for another vote. This looping continues until there are no more votes, at which point decision 465 branches to “No” branch 467 whereupon the tabulated votes data store file is sent to the receiving server (step 463) and mail forwarding processing ends at 470.

Receiving server processing commences at 475, whereupon the receiving server receives tabulated votes 458 from the forwarding server (step 480). The receiving server adds the votes to voter data store 484 (step 482). A determination is made as to whether there are more votes (decision 486). The receiving server may be receiving tabulated votes from many forwarding servers. For example, each forwarding server may collect votes for a certain precinct or area. If there are more tabulated votes, decision 486 branches to “Yes” branch 488 which loops back to receive more tabulated votes from other forwarding servers. This looping continues until no more tabulated votes are received, at which point decision 486 branches to “No” branch 490. Voting results are further tabulated (step 492), election winners are selected (step 494), and receiving server processing ends at 496.

FIG. 5 is a flow chart showing a forwarding server receiving votes, removing the voter identity, and sending the anonymous vote to a receiving server. Voter processing commences at 500, whereupon a voter sends a vote to the forwarding server (step 505). A determination is made as to whether the voter will receive a confirmation of his vote being processed by the forwarding server (decision 510). If a confirmation will not be sent, decision 510 branches to “No” branch 512 whereupon voter processing ends at 520. On the other hand, if a confirmation will be sent, decision 514 branches to “Yes” branch 514 whereupon processing waits for a confirmation (step 516). Once the confirmation is received at step 516, voter processing ends at 520.

Mail forwarding server processing commences at 525, whereupon the forwarding server receives a vote (step 530). The voter identity is retrieved from voter data store 540 (step 535). Voter data store 540 includes a log of who is authorized to vote and how many times a voter can vote. A determination is made as to whether the voter is authorized to vote (decision 545). For example, an authorization may be determined from an email address or determined from an authorized digital certificate or digital signature. It may also come from a voter entering a unique identifier and password on a touch-tone phone.

If the voter is not authorized to vote, decision 545 branches to “No” branch 547 whereupon the vote is disregarded (step 548). On the other hand, if the voter is authorized to vote, decision 545 branches to “Yes” branch 549 whereupon the voter identity is logged in voter data store 540 (step 550). The voter identity is removed at step 552. Removing voter identity may include removing the email address of the voter and relevant IP address information. The anonymous vote is sent to the receiving server (step 555). A determination is made as to whether a confirmation is feasible and requested by the voter to notify him that his vote is accepted or rejected (decision 560). For example, a confirmation may be feasible if a voter sent a vote from a private computer, but not feasible if a voter sent a vote from a public computer in a public library. In order to send a confirmation to an authorized voter whose identity has been removed, the voters' identity may have to be retrieved from the voter log file or retained in memory until the confirmation message has been sent.

If a confirmation will be sent, decision 560 branches to “Yes” branch 562 whereupon a confirmation is sent to the voter (step 563). The voter receives the confirmation at step 516, and voter processing ends at 520. On the other hand, if a confirmation will not be sent, decision 560 branches to “No” branch 564 whereupon a determination is made as to whether there are more votes (decision 565). This decision may be based on a time restriction (i.e. no votes after 5pm on November 4th). If there are more votes, decision 565 branches to “Yes” branch 568 which loops back to wait for another vote. This looping continues until there are no more votes, at which point decision 565 branches to “No” branch 567 whereupon forwarding processing ends at 570.

Receiving server processing commences at 575, whereupon the receiving server receives an anonymous vote from the forwarding server (step 580). The receiving server adds the votes to voter data store 584 (step 582). A determination is made as to whether there are more votes (decision 586). This decision may be based on a time restriction (i.e. no votes after 5pm on November 4^{th}) If there are more votes, decision 586 branches to “Yes” branch 588 which loops back to receive more votes from the mail forwarding server. This looping continues until no more votes are received, at which point decision 586 branches to “No” branch 590. Voting results are tabulated (step 592), a winner is selected (step 594), and receiving server processing returns at 596.

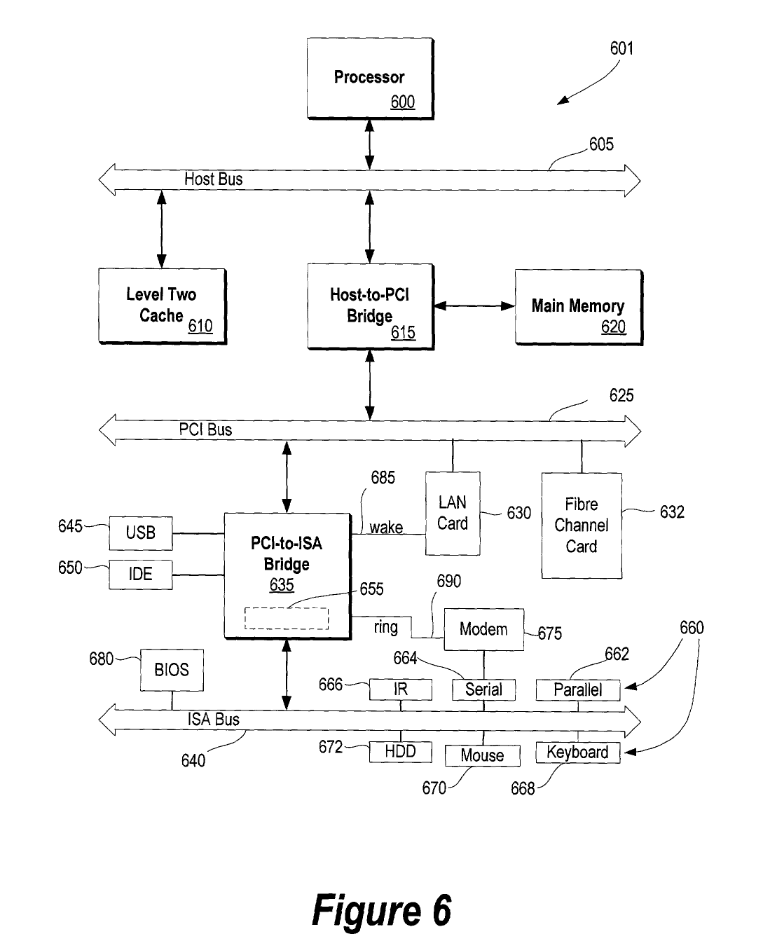

FIG. 6 illustrates information handling system 601 which is a simplified example of a computer system capable of performing the server and client operations described herein. Computer system 601 includes processor 600 which is coupled to host bus 605. A level two (L2) cache memory 610 is also coupled to the host bus 605. Host-to-PCI bridge 615 is coupled to main memory 620, includes cache memory and main memory control functions, and provides bus control to handle transfers among PCI bus 625, processor 600, L2 cache 610, main memory 620, and host bus 605. PCI bus 625 provides an interface for a variety of devices including, for example, LAN card 630. PCI-to-ISA bridge 635 provides bus control to handle transfers between PCI bus 625 and ISA bus 640, universal serial bus (USB) functionality 645, IDE device functionality 650, power management functionality 655, and can include other functional elements not shown, such as a real-time clock (RTC), DMA control, interrupt support, and system management bus support. Peripheral devices and input/output (I/O) devices can be attached to various interfaces 660 (e.g., parallel interface 662, serial interface 664, infrared (IR) interface 666, keyboard interface 668, mouse interface 670, and fixed disk (HDD) 672) coupled to ISA bus 640. Alternatively, many I/O devices can be accommodated by a super I/O controller (not shown) attached to ISA bus 640.

BIOS 680 is coupled to ISA bus 640, and incorporates the necessary processor executable code for a variety of low-level system functions and system boot functions. BIOS 680 can be stored in any computer readable medium, including magnetic storage media, optical storage media, flash memory, random access memory, read only memory, and communications media conveying signals encoding the instructions (e.g., signals from a network). In order to attach computer system 601 to another computer system to copy files over a network, LAN card 630 is coupled to PCI bus 625 and to PCI-to-ISA bridge 635. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for processing an electronic voting message, said method comprising:
receiving the electronic voting message from a client;
removing an identity of the client from the message,
wherein the removing results in an anonymous message; and
identifying one or more votes in the anonymous message.

2. The method as described in claim 1 further comprising:
determining whether the client is authorized to vote,
wherein the identifying is performed in response to the determination.

3. The method as described in claim 2 further comprising:
sending a confirmation message to the client, the confirmation message including a summary of the determination.

4. The method as described in claim 2 wherein the determining further comprises:
retrieving the identity of the client; and
comparing the identity of the client to one or more authorized identifiers retrieved from a voter data store.

5. The method as described in claim 1 wherein one of the votes includes a freeform comment.

6. The method as described in claim 1 further comprising:
modifying a total number of votes, the modifying further including:
adding the one or more votes to the total number of votes.

7. The method as described on claim 6 further comprising:
sending the total number of votes to a receiving server, wherein the receiving server is adapted to include the total number of votes with other received votes.

8. The method as described in claim 1 wherein the electronic message is selected from the group consisting of a phone-in message, a private client email message, a public client email message, a hypertext transfer protocol message, a computer network message, an Active X message, and a Java message.

9. An information handling system comprising:
one or more processors;
a memory accessible by the processors;
one or more nonvolatile storage devices accessible by the processors;
an electronic voting message handling tool to manage an electronic voting message stored on one of the nonvolatile storage devices, the electronic voting message handling tool including:
means for receiving the electronic voting message from a client;
means for removing an identity of the client from the message, wherein the removing results in an anonymous message; and
means for identifying one or more votes in the anonymous message.

10. The information handling system claim as described in claim 9 further comprising:
means for determining whether the client is authorized to vote, wherein the means for identifying is performed in response to the determination.

11. The information handling system claim as described in claim 10 further comprising:
means for sending a confirmation message to the client, the confirmation message including a summary of the determination.

12. The information handling system claim as described in claim 10 wherein the means for determining further comprises:
means for retrieving the identity of the client; and
means for comparing the identity of the client to one or more authorized identifiers retrieved from a voter data store.

13. The information handling system claim as described in claim 9 wherein one of the votes includes a freeform comment.

14. The information system handling claim as described in claim 9 further comprising:
means for modifying a total number of votes, the means for modifying further including:
means for adding the one or more votes to the total number of votes.

15. The information system handling claim as described in claim 14 further comprising:
means for sending the total number of votes to a receiving server, wherein the receiving server is adapted to include the total number of votes with other received votes.

16. The information system handling claim as described in claim 9 wherein the electronic message is selected from the group consisting of a phone-in message, a private client email message, a public client email message, a hypertext transfer protocol message, a computer network message, an Active X message, and a Java message.

17. A computer program product stored in a computer operable media for managing an electronic voting message, said computer program product comprising:
means for receiving the electronic voting message from a client;
means for removing an identity of the client from the message, wherein the removing results in an anonymous message; and
means for identifying one or more votes in the anonymous message.

18. The computer program product as described in claim 17 further comprising:
means for determining whether the client is authorized to vote, wherein the means for identifying is performed in response to the determination.

19. The computer program product as described in claim 18 further comprising:
means for sending a confirmation message to the client, the confirmation message including a summary of the determination.

20. The computer program product as described in claim 18 wherein the means for determining further comprises:
means for retrieving the identity of the client; and
means for comparing the identity of the client to one or more authorized identifiers retrieved from a voter data store.

21. The computer program product as described in claim 17 wherein one of the votes includes a freeform comment.

22. The computer program product as described in claim 17 further comprising:
means for modifying a total number of votes, the means for modifying further including:
means for adding the one or more votes to the total number of votes.

23. The computer program product as described in claim 22 further comprising:
means for sending the total number of votes to a receiving server, wherein the receiving server is adapted to include the total number of votes with other received votes.

24. The computer program product as described in claim 17 wherein the electronic message is selected from the group consisting of a phone-in message, a private client email message, a public client email message, a hypertext transfer protocol message, a computer network message, an Active X message, and a Java message.
